(19) United States
(12) Patent Application Publication
(10) Pub. No.: US 2025/0082000 A1
(43) Pub. Date: Mar. 13, 2025

(54) COMPOSITIONS FOR INGESTIBLE SUPPLEMENTS AND RELATED METHODS

(71) Applicant: doTERRA Holdings, LLC, Pleasant Grove, UT (US)

(72) Inventors: Alex McGregor DaBell, Springville, UT (US); Abdulla Khan, Pleasant Grove, UT (US); Russell Osguthorpe, Pleasant Grove, UT (US)

(73) Assignee: doTERRA Holdings, LLC, Pleasant Grove, UT (US)

(21) Appl. No.: 18/882,027

(22) Filed: Sep. 11, 2024

Related U.S. Application Data
(60) Provisional application No. 63/581,712, filed on Sep. 11, 2023.

(51) Int. Cl. A23L 33/135; A23L 33/125

(52) U.S. Cl. CPC A23L 33/135; A23L 33/125

(57) ABSTRACT

This application concerns compositions including at least one prebiotic and/or at least one probiotic and/or at least one postbiotic and/or at least one bacteriophage component(s). Also, methods for preparing prebiotic(s)+probiotic(s)+postbiotic(s)+bacteriophage(s) product formulation for animal or human consumption are disclosed, including by ingesting with water and or total composition as a fastmelt, with water, or other liquid in a shaker cup. Further, uses of said composition as a nutritional source or supplement for humans or animal are disclosed.

### CROSS-REFERENCE TO RELATED APPLICATION

This application claims the benefit under 35 U.S.C. § 119 (e) of U.S. Provisional Patent Application Ser. No. 63/581,712, filed Sep. 11, 2023, the disclosure of which is hereby incorporated herein in its entirety by this reference.

### FIELD

This disclosure relates generally to the field of microbiome health and nutrition and in particular dietary supplement food product formulations based on combining prebiotics, with probiotics with postbiotics plus bacteriophages for animal or human consumption, and methods and uses thereof. More specifically, disclosed embodiments relate to novel compositions, which may be marketed as dōTERRA PB Restore® ProBiome Complex, and which may include ingestible prebiotic(s) in disclosed amounts comprised and combined with disclosed amounts and ratio(s) of probiotics, and research-based doses of postbiotics plus disclosed amounts of certain bacteriophages. When combined, the disclosed compositions may provide positive outcomes for microbiome function and health.

### BACKGROUND

It is estimated that there are as many microbes in and on our bodies as there are human cells. These microbial colonies are called microbiomes. The microbiome functions as an invisible to the naked eye, organ and medical scientists agree a healthy or unhealthy microbiome influences nearly every aspect of our health outcomes and overall quality of life. The microbiome is made up of a variety of types of microbes' bacteria, archaea, protozoa, fungi, algae, lichens, molds, viruses, and prions. Each has a particular role to play in various biological functions.

### BRIEF SUMMARY

Disclosed embodiments may include compositions and methods of delivery for compositions including prebiotics, probiotics, post biotics and bacteriophages, which may help deliver to healthy human and animals, and those with compromised microbiomes with low diversity, and colony forming units which leads to GI disorders, pre-diabetic conditions with a unique system composed of composition(s) and deliveries as outlined below.

In some examples, provided are compositions comprising prebiotics, probiotics, postbiotics contributing at least 18 billion colony forming units and at least 36 billion colony forming units at the time of manufacture and bacteriophages at 5-20 mg per dose, from human, animal or plant origin identified by genus, species and strains contributing to the health of all major biomes. And can be consumed daily to help promote healthy metabolic function.

In other examples, the composition can comprise at least one prebiotic from inulin/chicory root or other fibrous source with food features providing fructooligosaccharide(s), at least one postbiotic metabolite producing source, and a minimum of 24 probiotic strains providing microbial diversity, stomach acid resistant, and/or microencapsulated for increased efficacy.

In other examples, the composition can have a decreased likelihood of stability issues in a sealed package than a single-component composition. The compositions can be used for animal or human consumption in a smoothie, fruit drink, shake, food coloring, flavoring, baby food, sports supplemental product, or other food product. In another aspect, the composition can be used in a product for topical use that is applied to body surfaces (e.g., skin or mucous membrane) or hair, such as, but not limited to, a lotion, household surface spray, cream, soap, gel, foam, ear drops, eye drops, inhalers (e.g., dry powder inhalers, metered-dose inhalers, nebulizers), mist and ointment. In another aspect, the composition can be used in a product for sun protection, including but not limited to sunscreen lotion or spray. In still further aspect, the compositions can further comprise additional ingredients such as herbs, spices, vitamins, minerals, food additives for preservation of and/or improved taste, freshness, or mouthfeel, or a combination thereof.

In other examples, compositions may include at least one probiotic (e.g., at least 24 probiotics), at least one postbiotic, and at least four bacteriophages combined with any of the constituents listed, which of which may each have a 1-99 weight percent of the composition.

In other examples, the composition is formulated as a liquid oil, dual chambered capsule, fast melt dissolvable powder, emulsion, effervescent tablet, gum, beadlet, softgel, powder, flakes, tablet, or capsule.

In other examples, use of the composition as a nutritional source or supplement for humans is contemplated.

In other examples, a method for preparing a microbial diverse dual chambered capsule and/or microencapsulated blend for animal or human consumption may involve: blending the composition for fast melt dissolvable delivery and/or added to a liquid (e.g., water) in a shaker cup, blender or added to water or a favorite cold beverage and then consumed.

### DETAILED DESCRIPTION

Throughout this application, several publications (including, without limitation, patents) are referenced herein. The disclosures of these publications in their entireties are hereby incorporated by reference in this application. Throughout this provisional application, several publications (including, without limitation, patents) are referenced herein. Disclosure of these publications in their entirety is hereby incorporated by reference in this provisional application.

The illustrative embodiments herein described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, can be arranged, substituted, combined, and designed in a wide variety of different configurations, all of which are explicitly contemplated and made part of this disclosure.

The inventors have found bacterial composition to be more diverse in youth microbiomes compared to adults. Both youth and adult microbiomes are predominantly impacted by health habits, biological gender, and weight status. Additionally, the inventors have learned that some children, adolescents, and many adults are lacking healthy microbial diversity and total healthy microbes throughout their major biomes including the digestive biome, respiratory biome, oral biome, urobiome, and skin biome. As humans age, our microbioal diversity declines. A diverse microbiome with the right amount of total healthy microbes can mitigate, and inhibit many common ailments including obesity, gastrointestinal diseases and disorders, urinary tract and other related infections, vascular maladies, cognitive conditions, respiratory illnesses, oral illness and infection, a multiplicity of skin related disorders, and reproductive disorders and functionality. Microbiome dysbiosis has been associated with various local and systemic human diseases including cardiovascular disease, obesity, periodontal disease and others. Dysbiosis has also been in elderly populations, smokers, and following antibiotic treatment. Dysbiosis can lead to the disruption of the gut lining, causing enhanced permeability or ‘leaky gut.’ The junctions between the epithelial cells typically prevent the movement of bacteria and molecules across the gut wall. The integrity loss may allow protein to enter the bloodstream and interact with the immune system and may lead to autoimmune disorders and allergies.

A “prebiotic” is a fibrous food substrate that is selectively used by and degraded by gut microbiota, which may provide a health benefit to the host. Their connection to human health has been researched heavily in recent years. As they feed the intestinal microbiota, short chain fatty acids are released into the blood stream affecting the gastro-intestinal (GI) tract and distant organs. Fructo-oligosaccharides and galacto-oligosaccharides are two illustrative groups of prebiotics, and both have demonstrated health benefits for humans and animals. Illustrative health benefit examples include abilities to affect intestinal function, metabolism, and immunomodulatory molecules with antagonistic effects against pathogens. Additional prebiotic studies have demonstrated improvement in airways and macrophages through the propionate affects T helper 2, as well as the dendritic cells in the bone marrows. Additionally, short chain fatty acids produced by prebiotic microbiota feeding decrease the pH of the colon and stimulate the immune systems protection against pathogenic microorganisms.

The term “probiotics” refers to living healthy microorganisms which may confer health benefits to hosts when administered in adequate amounts. For example, probiotics may come from human, animal, or plant sources, may be safe and free of vectors that are able to transfer resistance to anti-biotics and may be free of pathogenicity or toxicity factors. Additionally, a probiotic may have great capacity to survive under acidic pH conditions, enzymes, biliary salts. Probiotics may demonstrate antagonism against harmful pathogens and provide health benefits to the host. Lastly, the probiotic may demonstrate efficacious activity, viability and growth. Various probiotics may either be declared as transient in nature or residential. This gastrointestinal biological activity can assist in classifying composition features and survivability of probiotics. R. J. Boyle, R. M. Robins-Browne, and M. L. Tang, “Probiotic use in clinical practice: what are the risks?,” Am. J. Clin. Nutr., vol. 83, no. 6, pp. 1256-1264 June 2006. M. E. Sanders, “Probiotics: Definition, Sources, Selection, and Uses,” Clin. Infect. Dis., vol. 46, no. s2, pp. S58-S61, February 2008, doi: 10.1086/523341. F. Guarner and J. R. Malagelada, “Gut flora in health and disease,” Lancet Lond. Engl., vol. 361, no. 9356, pp. 512-519, February 2003, doi: 10.1016/S0140-6736 (03) 12489-0. F. Bäckhed, R. E. Ley, J. L. Sonnenburg, D. A. Peterson, and J. I. Gordon, “Host-bacterial mutualism in the human intestine,” Science, vol. 307, no. 5717, pp. 1915-1920 March 2005, doi: 10.1126/science.1104816. C. M. Thomas and J. Versalovic, “Probiotics-host communication: Modulation of signaling pathways in the intestine,” Gut Microbes, vol. 1, no. 3, pp. 148-163, June 2010.

Postbiotics is a term derived from the Greek for “post” meaning after, and bios meaning life. These substances may include “after living” probiotics which are non-viable microbes or cell fragments, with or without metabolites that may provide a documented health benefit. For example, the term postbiotic may refer to the substances derived after the microorganisms are no longer alive, or, in other words, inanimate, intact cells or structural fragments of microbes, such as cellular walls. Most postbiotics also retain microbe produced substances, such as metabolites, proteins, and peptides, which may contribute to the health benefits of the host. A postbiotic may be derived from a well-defined microorganism for which a genomic sequence has been identified and established using a technological process of biomass production and inactivation, i.e., heat inactivated, which can be reliably reproduced.

Consuming healthy foods including fermented foods may contribute to A key microbial diversity and gut health. Consuming, for example, yogurts, aged cheeses, pickled vegetables, kefir, kimchi, sauerkraut, miso, tempeh and other live active cultures may positively impact the microbiome. Living an active lifestyle and exercising daily have also been shown to improve microbial health, mitigate and prevent disease and prolong health-span. Exercise helps enrich he microflora diversity; improving the Bacteroidetes-firmicutes ratio which may contribute to reducing weight, obesity associated pathologies, and GI disorders; stimulating the proliferation of bacteria which can modulate mucosal immunity and improve barrier functions. Fermented foods have been an important part of the human diet for centuries, and their diversity is substantial. The health benefits of fermented foods have been intensively investigated; consuming bioactive peptides and microbial metabolites in fermented foods positively affects human health and provides a distinct and diverse population of microorganisms. Supplementing our diet with healthy prebiotics, probiotics, postbiotics and bacteriophages while consuming fruits, vegetables, roots and stems and herbal botanicals and phytonutrient constituents may also assist in providing normalized blood glucose levels, improved body composition, collagen synthesis, cognitive function, epidermal appearance/health and adipogenesis fat health benefits. Additionally, the metabolite components associated with postbiotics particularly may demonstrate beneficial effects for the human body.

The World Health Organization (WHO) recommends that all adults participate in 150-300 minutes of moderate intense aerobic activity, and 75-150 minutes of vigorous intense physical activity throughout the week. Additionally, WHO recommends limiting the amount of time spent being sedentary and replacing sedentary time with physical activity of any intensity to help reduce the detrimental effects of metabolic syndrome. Physical activity is essential to promote healthy microbial health and immune function.

Upon reaching adulthood, the diversity of healthy microbial probiotic cells declines. This is likely due to changes in physiology, diet, medication, and lifestyle choices. Decreased diversity is considered an indicator of an unhealthy microbiome and is linked to various conditions such as obesity and type 2 diabetes. In addition to decreased diversity, the changes of the biomes throughout the body create an imbalanced state, dysbiosis then leads to inflammatory and neurodegenerative disorders such as Alzheimer's disease, Parkinsons disease. E. B. Hollister et al., “Structure and function of the healthy pre-adolescent pediatric gut microbiome,” Microbiome, vol. 3, p. 36, 2015, doi: 10.1186/s40168-015-0101-x.

A review of clinical and preclinical research suggests that supplementation with prebiotics (FOS) may support gastrointestinal health (IBS and Crohn's disease, colorectal cancer, necrotizing enterocolitis), immune system, nervous system, skin, and cardiovascular system. However, this study does cite that it takes 2.5-10 g/day of prebiotics to exert beneficial functions on human health D. Davani-Davari et al., “Prebiotics: Definition, Types, Sources, Mechanisms, and Clinical Applications,” Foods, vol. 8, no. 3, March 2019, doi: 10.3390/foods8030092.

In a review of clinical and preclinical findings, supplementation with dietary FOS and potential benefits on health proposed a dose of 4-15 g/day given to healthy subjects may reduce constipation, stimulate the growth of nonpathogenic intestinal microflora (prebiotic effect), offer immune system support in offspring through breastmilk or formula, and may help with nutrient absorption in clinical trials. Preclinical trials show that FOS may help regulate lipid metabolism and reduce occurrence of colon cancer. M. Sabater-Molina, E. Larqué, F. Torrella, and S. Zamora, “Dietary fructooligosaccharides and potential benefits on health,” J. Physiol. Biochem., vol. 65, no. 3, pp. 315-328, September 2009, doi: 10.1007/BF03180584.

Synbio L. Rhamnosus IMC 1505+L. Paracasei IMC502 have demonstrated to increase healthy bacterial counts, while inhibiting unhealthy pathogenic bacteria. Studies have also shown these two strains improve recovery time, reduce fatigue and tiredness after rigorous activity by lowering exercise induced oxidative stress. These strains are also supported with clinical research supporting gastrointestinal function and promoting healthy immune response. Reproductive and urobiome research studies have been shown to stabilize vaginal biome balance by increasing Lactobacillus abundance. When combined together they may help lower reactive oxygen metabolites after exertion, and maintain healthy immune function, strength and efficiency of GI tract when responding to stressful conditions.

B. animalis ssp. Lactis BLC1 promote lactose digestion to suppress occasional bloating or digestive discomfort. This strain has shown to maintain healthy bowel Fitzpatrick scores and support digestive health including reducing bloating, gas, and relieving occasional constipation. In a review of clinical and preclinical research, preclinical research shows that BB 12 demonstrated to have high gastric and bile tolerance, adheres well to human mucus, inhibits pathogens in that can invade the GI tract, has an immune modulating effect (interacts with immune cells and can induce IL-1βB, IL-6, IL-10, IL-12 and IFN-γ, TNF-α). Clinical research summarized includes 130 studies, dating back to 1987, has been tested on infants to elderly, and has been administered in dosages up to 100 billion CFU/day. Sample size ranges from 15 to 343 participants. These studies have shown that BB12 survives in the GI tract, can modulate microflora, in the gut, improves digestion, soothes the gut, can decrease the severity and duration of respiratory infections, and may help the body become more resistant to infections strain of BLC-1. M. Jungersen, A. Wind, E. Johansen, J. E. Christensen, B. Stuer-Lauridsen, and D. Eskesen, “The Science behind the Probiotic Strain Bifidobacterium animalis subsp. lactis BB-12®,” (Bioidentical BLC1) Microorganisms, vol. 2, no. 2, Art. no. 2, June 2014, doi: 10.3390/microorganisms2020092. In a randomized, double-blind, placebo-controlled trial (n=210; healthy children who attend daycare), supplementation with BB12 (Bioidentical BLC1) (109 CFUs/day for 3 months) has no effect on preventing GI or respiratory tract infections and does not show any effect on duration, number of children, or days absent from daycare. I. Hojsak, A. Močić Pavić, T. Kos, J. Dumančić, and S. Kolaček, “Bifidobacterium animalis subsp. lactis in prevention of common infections in healthy children attending day care centers-Randomized, double blind, placebo-controlled study,” Clin. Nutr., vol. 35, no. 3, pp. 587-591, June 2016, doi: 10.1016/j.clnu.2015.05.004. In a randomized, partially blinded, 4-period crossover study (n=30; healthy adults; ages 18-40), drinking a yogurt smoothing with BB12 or taking a capsule with BB12 (Bioidentical BLC1) (both interventions included 1010 CFUs/day for 4 weeks) had an anti-inflammatory effect (lower expression of TLR-2 and TNF-a) [98]. Y. Lee et al., “Effects of Bifidobacterium animalis subsp. lactis BB-12® (Bioidentical BLC1) on the lipid/lipoprotein profile and short chain fatty acids in healthy young adults: a randomized controlled trial,” Nutr. J., vol. 16, p. 39, June 2017, doi: 10.1186/s12937-017-0261-6.

L. acidophilus LA1 offers digestive health support, stimulates natural immune system function by inhibiting harmful pathogenic activity. L. acidophilus LA1 has been shown to improve lipid metabolism, and producing enzymes associated with supporting cardiovascular health. In a review of preclinical studies, L. acidophilus NCFM demonstrated the promotion of healthy cholesterol levels, positively influence the gastrointestinal tract, reduce carcinogenicity, and promote an immune response to oral antigens [51]. NOTE: this is a bioidentical strain of LA-1. M. E. Sanders and T. R. Klaenhammer, “Invited Review: The Scientific Basis of Lactobacillus acidophilus NCFM Functionality as a Probiotic,” J. Dairy Sci., vol. 84, no. 2, pp. 319-331, February 2001, doi: 10.3168/jds.S0022-0302 (01) 74481-5.

L. brevis SP48 supports mood, sleep and cognitive function by naturally increasing GABA levels by supporting principal neurotransmitter of the central nervous system.

L. rhamnousus LB21 helps maintain oral health and supports healthy teeth throughout life. In a randomized placebo controlled trial (n=160; healthy individuals; 58-84 years old; primary root caries lesions), supplementation with LB21 (107 CFU/mL; 200mL milk once a day for 15 months) resulted in significantly higher numbers of root caries index reversal (RCI) and remineralization based on electric resistance measurements (ECM) [118]. Measurements determined by saliva samples, RCI and ECM. L. G. Petersson, K. Magnusson, U. Hakestam, A. Baigi, and S. Twetman, “Reversal of primary root caries lesions after daily intake of milk supplemented with fluoride and probiotic lactobacilli in older adults,” Acta Odontol. Scand., vol. 69, no. 6, pp. 321-327, November 2011, doi: 10.3109/00016357.2011.568962.

L. reuteri LR92 has been shown to reduce the occurrence of digestive discomfort in infants as part of a maternal supplementation during the last four weeks of pregnancy. In a randomized, double-blind, placebo-controlled trial (n=145; pregnant women; Iranian; 18-49 years old), supplementation with LR92 (1×108 CFUs/day starting the 35th week of pregnancy; followed for 5 months post-partum) significantly lowered the incidence and severity of infantile colic in offspring as measured by questionnaires and clinical evaluation Enterococcus faecium SF-68 [127]. M. A. Pourmirzaiee, F. Famouri, W. Moazeni, A. Hassanzadeh, and M. Hajihashemi, “The efficacy of the prenatal administration of Lactobacillus reuteri LR92 DSM 26866 on the prevention of infantile colic: a randomized control trial,” Eur. J. Pediatr., vol. 179, no. 10, pp. 1619-1626 October 2020, doi: 10.1007/s00431-020-03641-4.

B. breve BBr-8 sustains healthy microbiota for improved digestive health, boosts the immune system.

Lactococcus lactis ssp. Lactis SP38 supports gut immune function, fortifying healthy bacteria colonization, while inhibiting the spread of unwanted bacteria.

B. bifidum SP9 helps stimulate immune response and digestive health in infants.

L. casei BGP 93 demonstrates antimicrobial properties that support gut immune function and inhibit the spread of pathogens and harmful bacteria.

L. fermentum LF2 improves lipid metabolism, benefiting overall health, while improving long-term quality of life and wellness. Multiple studies confirm that LF2 has also been shown to support gut health by releasing specific healthy microbial molecules.

L. helveticus SP27 improves systemic health by improving bioavailability of food components and modulating microbiota composition and beneficial metabolites. L. helveticus also activates immune response, healthy vascular elasticity, flow and circulation.

L. paracasei BGP2 positively impacts intestinal and immune pathways for biological health benefits, improves lipid metabolism, enhances GI health and disorders and enhances gut health function.

L. plantarum 14D modulates healthy microbiota for improved digestive health, sustains bifodabacteria, which is a beneficial healthy bacterium that declines with age.

S. thermophilus SP4 maintains healthy microbiota balance and improves lactose digestion.

L. crispatus SP28 maintains predominance of lactobacilli and supports a healthy vaginal ecosystem.

L. delbruecki ssp. Bulgaricus LB2 aids in lactose digestion, and sustains healthy microbiota for improved digestive health. In vitro research shows that LB-2 has inhibitory activity against H. pylori strains, including those that are antibiotic resistant. LB-2 had better activity at low pH values but were able to cause inhibitory activity in the neutralized pH ranges as well. L. Boyanova, M. Stephanova-Kondratenko, and I. Mitov, “Anti-Helicobacter pylori activity of Lactobacillus delbrueckii subsp. bulgaricus strains: preliminary report,” Lett. Appl. Microbiol., vol. 48, no. 5, pp. 579-584, May 2009, doi: 10.1111/j.1472-765X.2009.02571.x. Measurements determined by agar-well diffusion. In vitro research shows that LB-2 can withstand low pH levels and 0.1-0.3% bile salt concentrations, which indicates that it may make it past the stomach and into the intestines. Measurements determined by spectrophotometry. R. Yi, F. Tan, T. Liu, and X. Zhao, “Probiotic properties of Lactobacillus strains isolated from Xinjiang naturally fermented yogurt,” presented at the 2ND INTERNATIONAL CONFERENCE ON FRONTIERS OF BIOLOGICAL SCIENCES AND ENGINEERING (FSBE 2019), Jinan City, China, 2020, p. 020016. doi: 10.1063/5.0000021.

B. longum ssp. Infantis SP37 aids in the proper development and strengthening of immune functions in infants.

B. longum ssp. Longum SP54 supports the intestinal barrier to help inhibit unwanted microbes from growing.

L. gasseri SP33 maintains predominance of lactobacilli and a healthy vaginal ecosystem.

L. salivarius SP2 supports gut immune function, inhibiting the spread of pathogens and harmful microbes.

Lactobacillus rhamnosus SP-1 In a randomized, double-blind, placebo-controlled, parallel trial (n=28; healthy with periodontitis; male/female; ages 35-68 years old), supplementation with SP-1 (2×107 CFU dissolved in water once a day for 3 months after scaling and root planning) resulted in greater reductions in periodontitis compared to control and a reduced need for surgery at the 1 year follow up [113]. Measurements determined by clinical examination. Alicia Morales et al., “Clinical Effects of Lactobacillus rhamnosus in Non-Surgical Treatment of Chronic Peiodontitis: A Randomized Placebo-Controlled Trial with 1-Year Follow-Up.” Wiley, 2016. In a randomized, double-blind, placebo-controlled, parallel trial (n=47; healthy with periodontitis; male/female), supplementation with SP-1 (2×107 CFU dissolved in water once a day for 3 months after scaling and root planning) resulted in greater reductions in periodontitis-causing bacteria (T. forsythia, P. gingivalis, A. actinomycetemcomitans) compared to placebo at the 9-month follow up and performed similarly to the antibiotic Azithromycin 500 mg. Measurements determined by clinical examination. A. Morales et al., “Microbiological and clinical effects of probiotics and antibiotics on nonsurgical treatment of chronic periodontitis: a randomized placebo-controlled trial with 9-month follow-up,” J. Appl. Oral Sci., vol. 26, no. 0, January 2018, doi: 10.1590/1678-7757-2017-0075. In a randomized triple-blind controlled trial (n=36; elderly; denture stomatitis; Chilean; male/female), supplementation with SP-1 107 CFU/day in milk for 6 months (significantly reduced the incidence and severity of stomatitis and reduced Candida counts as measured by clinical examination and saliva samples). X. Lee, C. Vergara, and C. Lozano, “Severity of Candida-associated denture stomatitis is improved in institutionalized elders who consume Lactobacillus rhamnosus SP 1,” Aust. Dent. J., vol. 64, no. 3, pp. 229-236, September 2019, doi: 10.1111/adj.12692.

Postbiotic strain L. rhamnous CRL 1505 HI functions like a ghost probiotic. It's an after-life, nonliving probiotic that's still recognized by your epithelial and immune cells. Comparative studies about this strain have demonstrated this heat-inactivated immunobiotic provides a cell wall and peptidoglycan, supporting the innate immune response related to respiratory health.

Bacteriophages LH01-Myoviridae, LL5-Siphoviridae, T4D-Myoviridae, and LL12-Myroviridae seek out unwanted microbes that can compromise digestive health, urinary tract health, and other systems of the body. They effectively clear space for probiotics to do their important work. They destabilize the cell walls of the unhealthy and harmful bacteria and take over important functions to reduce and eliminate their impact. Phages may not infect host bacteria and may only target those that are harmful to the microflora of the intestines S. Chibani-Chennoufi, J. Sidoti, A. Bruttin, E. Kutter, S. Sarker, and H. Brüssow, “In Vitro and In Vivo Bacteriolytic Activities of Escherichia coli Phages: Implications for Phage Therapy,” Antimicrob. Agents Chemother., vol. 48, no. 7, pp. 2558-2569 July 2004, doi: 10.1128/AAC.48.7.2558-2569.2004. Bacteriophages are a natural part of the human gastrointestinal system and are often found in numerous amounts, similar to bacteria in the gut A. Górski and B. Weber-Dabrowska, “The potential role of endogenous bacteriophages in controlling invading pathogens,” Cell. Mol. Life Sci., vol. 62, no. 5, pp. 511-519, March 2005, doi: 10.1007/s00018-004-4403-6.

Additionally, studies have also shown that diets high in healthy flora from plant foods are associated with reduced risk of various types of cancers. These studies correlate diets rich in fresh and safely fermented fruits and vegetables and nutrients from these diets, such as vitamin C, vitamin A, and dietary fiber, prebiotics, probiotics and postbiotics, with reduced cancer risk. Persons consuming these diets frequently have high intakes of these nutrients.

There are many barriers that prevent consumption of fermented foods, prebiotic fibrous nutrients, probiotics, postbiotics and bacteriophages. Geographically, there are nutrient rich-deprived areas where people live who are not adequately nourished or do not have access to vegetables, fermentation equipment, fruits, herbs and phytonutrients that may contribute healthy microbial balance and nutritional content. Further, many homes no longer plant, cultivate, harvest or raise livestock or have access to human microbes from breast milk or the ability to supply sources of healthy flora from these sources.

There remains a need, therefore, for convenient vehicles for healthy flora, from human, animal livestock, or a variety of botanical plants and extracts that contribute healthy microbial colonies that are survivable, stable and have a healthy and lengthy shelf-life.

Disclosed embodiments may be based upon the discovery of combining prebiotic fibers plus probiotic strains plus postbiotic strains plus bacteriophages, that can provide a stable source of stomach resistant microbial diversity with a long shelf-life, and provide GI and other microbiome health benefits, derived from human, animal, and fermented forms of plants, seeds, stems, oils, the fruits and vegetables. Also, such compositions are formulated in a manner that promotes convenience of use and improved cellular absorption. Further, no artificial flavors, preservatives, colors, binders, or fillers are added into the compositions of the present invention since the preparation process discussed herein (e.g., harvesting, fermentation, and drying techniques) preserves a high amount of colony forming units, active fluorescing units, and other microbial health-enriching characteristics of each compound or constituents used in the compositions discussed herein.

Prebiotics may be harvested at or near the time of desired nutrient fiber content, richness, freshness, taste, appearance, condition, and desired macronutrient value. Because of the nature of harvesting and handling, speed of harvesting and handling may maintain and improve the characteristics of the prebiotics. Any techniques known to those in the art may be used to extend postharvest shelf life, including removal from direct sunlight and reducing the respiration by hydro or rapid cooling; slow respiration by maintaining optimal shipping and storing environment; or maintaining optimal relative humidity. Special skills may be utilized for proper harvesting, handling, grading to promote desired quality. Prebiotics from roots, stalks, fruit, stems, peels may be prepared, with care under predetermined quality requirements. Additional measures may be taken to ensure high quality, premium, prebiotic(s).

The prebiotics, probiotics, and postbiotic compositions described herein may be grouped by efficacy and efficiency in formulation. Generally, essential oils can be grouped together by liquid delivery when in oil form and when dried combined with dried constituents.

Each prebiotic, probiotic, postbiotic, and/or bacteriophage with its constituent component can be provided in any concentration. For example, each component can be about 1% by weight, about 2% by weight, about 4% by weight, about 5% by weight, about 10% by weight, about 15% by weight, about 18% by weight, about 20% by weight, about 22% by weight, about 23% by weight, about 24% by weight, about 25% by weight, about 30% by weight, about 35% by weight, about 40% by weight, about 45% by weight, about 50% by weight, about 55% by weight, about 60% by weight, about 70% by weight, about 80% by weight, about 90% by weight, or about 99% by weight. Also, each component can have a range (by weight) of 1%- 2%; 2%- 4%; 1%- 5%; 2%- 4%; 2%- 5%; 4%- 6%; 5%- 7%; 6%- 8%; 7%- 10%; 8%-11%; 8%- 14%; 9%- 14%; 12%- 14%; 15%- 19%; 15%- 22%; 15%- 24%; 19%- 21%; 19%- 24%; 21%- 24%; 24%- 33%; 25%- 30%; 1%- 15%; 1%- 18%; 1%- 20%; 1%- 22%; 1%- 23%; 1%- 24%; 1%- 25%; 1%- 30%; or 30%- 99%.

Prebiotic+Probiotic+Postbiotic+Bacteriophage compositions can include a 1 or more prebiotic component(s), a greater number of probiotic strains or bioidentical equivalent (e.g., 24 probiotic strains or bioidentical equivalent)+at least one postbiotic(s) plus a quantity of bacteriophages intermediate the numbers of prebiotic and probiotic components (e.g., at least four bacteriophages), which may provide active compounds, feature sets in certain ratios and levels present in a portion ranges of approximately 0.1 mcg to 20,000 mg/day or 1000 mcg to 20,000 mg/day from microbial sources including but not limited human, animal, and fermented plants, fruits, or vegetable sources in certain ratios and levels present in a portion ranges of approximately 0.1 mcg to 20,000 mg/day.

The compositions described herein may include ratios and levels of microbial prebiotics, probiotics, postbiotics, digestive enzymes, organic substances, metabolites, from sourced human, animal and/or plant phytonutrient families. Formulated by combining all four microbial types by efficacy and effectiveness as disclosed herein. Such substances in these compositions may aid in the normalization of digestive health, blood glucose, insulin response, metabolic function, cognitive function, skin health, vascular function, urobiome function including urinary tract, reproductive, and kidney function and metabolic performance. Combined with healthy lifestyle choices, compositions in accordance with this disclosure may assist with the prevention and/or treatment of tumor growth, cancer formation, cancer diffusion, abnormal angiogenesis, neuroprotective disorder, diabetes, inflammation, atherosclerosis, viral infection, toxicity, glycemia, oxidation, leishmanial, molluscicidal, choleretic, spasmodic, immune and autoimmune disease, blood coagulation, osteoarthritis, rheumatoid arthritis, cataracts, liver malfunction, kidney disease, blood sugar disorders, fatigue, wound healing, and metabolic syndrome.

### Prebiotic, Probiotic, Postbiotic and Bacteriophage Preparation Techniques

Probiotic strains may be bacteria, which may be characterized as distinct and separate entities in the classification of all living organisms. Probiotic microorganisms can come from a variety of sources, origins and areas. The source or origin does not determine what the microorganism is comprised of, nor do they bring any component of where they are found or isolated from. Human beings are born without a microbial population, and the resident microbes of any person develop and populate throughout the stages of life, beginning at birth. Newborn babies' first exposure to the development of a microbiome may begin during vaginal delivery. Breastfeeding further plants those healthy microbes on and inside of the infant. As the newborn grows and begins eating foods, and is exposed to people and the environment, the microbiome continues to become more diverse forming colonies and cohabitating with the host. The microorganisms found in humans coexist with and take up residency in/on their hosts until they mature and become postbiotic metabolites, providing further health benefits. The unique microbial prebiotic compounds, probiotic strains, postbiotic metabolites and bacteriophage composition has shown to demonstrate positive health benefits related to the digestive tract, oral biome, urogenital biome, respiratory biome, skin biome and vascular system.

Antibiotics have proven to help prevent, treat and cure various bacterial pathogenesis including but not limited to conjunctivitis, otitis media, sexually transmitted diseases, skin or soft tissue infections, streptococcal pharyngitis, travelers' diarrhea, upper respiratory infections, urinary tract infections and much more. While antibiotics can be an important part of immediate acute treatments, the long-term impact and effect are currently under scrupulous review for their long-term impact on human health and wellness. The overuse and misuse of antibiotics, especially taking them for the wrong bacterial infection has been shown to promote anti-biotic resistance. According to the Center for Disease. Control and Prevention about one-third of antibiotic use in people is not needed or appropriate. (Journal of the American Medical Association by the Centers for Disease Control and Prevention, in collaboration with Pew Charitable Trusts and other public health medical experts.). Improving antibiotic use to combat antibiotic resistance is imperative for our future.

Probiotics may be consumed (e.g., daily) to aid the replenishment of healthy colonies throughout all of the major biomes and to implicitly prevent the need for and augment the use of antibiotics. Recent evidence now confirms that probiotic strains can act as amplifying compounds to inhibit the adverse effects of antibiotics (Can J Infect Disease Medical Microbiology. 2006 September-October; 17 (5): 291-295 doi: 10.1155/2006/934626). Probiotics are the difference between a good quality of life and a bad one. Continued research and improvement in healthy microbial clinical studies, manufacturing, and regulatory standards, have enabled accelerated research and therapy solution progress to ensure that medical physicians, research scientists, pharmaceuticals, and dietary supplements and consumers have reliable, proven products for safe and efficacious use. Multiple probiotic organisms may help modulate immunity. Probiotics generally play a role in eradicating pathogens from local and distant mucosal sites. Pathogenic bacteria living in the respiratory system beginning with the nose can be prophylactically treated by ingesting specific probiotic species and strains. This not only implies, but concludes an immunological interference.

The compositions described herein can also include any other ingredients deemed desirable or known in the art, such as, but not limited to, the following: vitamins, minerals, antioxidants, spices, herbs, or other natural food additives for the preservation of taste, freshness, consistency or mouthfeel. Such additives are well known in the art.

Inclusive but not limited to: prebiotics Fructooligosaccharide, probiotics Lactobacillus plantarum 14D, Bifidobacterium animalis ssp. Lactis BLC-1, Lactobacillus rhamnosus SP-1, Lactobacillus paracasei IMC-502, Lactobacillus rhamnosus IMC-501, Bifidobacterium breve Bbr-8, Lactobacillus acidophilus LA-1, Lactobacillus paracasei BGP-2, Lactobacillus rhamnosus LB-21, Streptococcus thermophilus SP-4, Lactobacillus brevis SP-48, Bifidobacterium bifidum SP-9, Lactobacillus casei BGP-93, Lactobacillus fermentum CS-57, Lactobacillus helveticus SP-27, Lactobacillus reuteri LR-92, Enterococcus faecium SF-68, Lactococcus lactis ssp. Lactis SP-38, Bifidobacterium longum ssp. Longum SP-54, Bifidobacterium longum ssp. Infantis SP-37, Lactobacillus delbrueckii ssp. Bulgaricus LB-2, Lactobacillus crispatus SP-28, Lactobacillus gasseri SP-33, Lactobacillus salivarius SP-2; Postbiotics: L. Rhamnosus CRL 1505 HI, and Bacteriophages LH01-myoviridae, LL5-Siphoviridae, T4D-Myoviridae, LL12-Myoviridae.

TABLE 1

| Prebiotics | Probiotics | Postbiotics | Bacteriophages |
|---|---|---|---|
| Fructooligosaccharide | Lactobacillus plantarum 14D | L. Rhamnosus | LH01-myoviridae |
| | Bifidobacterium animalis ssp. Lactis BLC-1 | CRL 1505 HI | LL5-Siphoviridae |
| | Lactobacillus rhamnosus SP-1 | | T4D-Myoviridae |
| | Lactobacillus paracasei IMC-502 | | LL12-Myoviridae |
| | Lactobacillus rhamnosus IMC-501 | | |
| | Bifidobacterium breve Bbr-8 | | |
| | Lactobacillus acidophilus LA-1 | | |
| | Lactobacillus paracasei BGP-2 | | |
| | Lactobacillus rhamnosus LB-21 | | |
| | Streptococcus thermophilus SP-4 | | |
| | Lactobacillus brevis SP-48 | | |
| | Bifidobacterium bifidum SP-9 | | |
| | Lactobacillus casei BGP-93 | | |
| | Lactobacillus fermentum CS-57 | | |
| | Lactobacillus helveticus SP-27 | | |
| | Lactobacillus reuteri LR-92 | | |
| | Enterococcus faecium SF-68 | | |
| | Lactococcus lactis ssp. Lactis SP-38 | | |
| | Bifidobacterium longum ssp. Longum SP-54 | | |
| | Bifidobacterium longum ssp. Infantis SP-37 | | |
| | Lactobacillus delbrueckii ssp. Bulgaricus LB-2 | | |
| | Lactobacillus crispatus SP-28 | | |
| | Lactobacillus gasseri SP-33 | | |
| | Lactobacillus salivarius SP-2 | | |

Additional embodiments within the scope of this disclosure will now be described in greater detail by reference to the following non-limiting examples.

### EXAMPLES

### Example 1—Formulation of Prebiotics+Probiotics+Postbiotics+Bacteriophages

To formulate the prebiotics+probiotics+postbiotics+bacteriophages, all may be sourced from the quality survivable sources including but not limited to human, animal, plant sources.

Fermented compounds may be sustainably developed, manufactured, and/or harvested, at the time of desired nutrient richness, heightened value, appearance, potency, condition, sourced at the desired biological value. Because of the perishable nature of some origins, sources of plants, microbial sourcing, harvesting, and handling quality, and speed and maintain and preserve quality. Several techniques that are used to extend fermented timing, postharvest shelf life is known to those of skill in the art, and one or more of the following is employed: refrigeration, sublimation, fermentation practices, protection from direct sunlight, relative high humidity, pressure, and by maintaining controlled shipping refrigerated containment and storage environment(s); and/or maintaining controlled relative humidity and temperature.

TABLE 2
Prebiotics + Probiotics + Postbiotics +
Bacteriophage COMPOSITIONS

| Component Genus/Species Strain or compound | CFU/Weight % |
|---|---|
| Fructooligosaccharide Prebiotics | <1-80% |
| Lactobacillus plantarum 14D | <1-75% |
| Bifidobacterium animalis ssp. Lactis BLC-1 | <1-75% |
| Lactobacillus rhamnosus SP-1 | <1-75% |
| Lactobacillus paracasei IMC-502 | <1-75% |
| Lactobacillus rhamnosus IMC-501 | <1-75% |
| Bifidobacterium breve Bbr-8 | <1-75% |
| Lactobacillus acidophilus LA-1 | <1-75% |
| Lactobacillus paracasei BGP-2 | <1-75% |
| Lactobacillus rhamnosus LB-21 | <1-75% |
| Streptococcus thermophilus SP-4 | <1-75% |
| Lactobacillus brevis SP-48 | <1-75% |
| Bifidobacterium bifidum SP-9 | <1-75% |
| Lactobacillus casei BGP-93 | <1-75% |
| Lactobacillus fermentum CS-57 | <1-75% |
| Lactobacillus helveticus SP-27 | <1-75% |
| Lactobacillus reuteri LR-92 | <1-75% |
| Enterococcus faecium SF-68 | <1-75% |
| Lactococcus lactis ssp. Lactis SP-38 | <1-75% |
| Bifidobacterium longum ssp. Longum SP-54 | <1-75% |
| Bifidobacterium longum ssp. Infantis SP-37 | <1-75% |
| Lactobacillus delbrueckii ssp. Bulgaricus LB-2 | <1-75% |
| Lactobacillus crispatus SP-28 | <1-75% |
| Lactobacillus gasseri SP-33 | <1-75% |
| Lactobacillus salivarius SP-2 | <1-75% |
| L. Rhamnosus CRL 1505 HI | <1-75% |
| LH01-myoviridae (Postbiotic) | <1-80% |
| LL5-Siphoviridae | <1-80% |
| T4D-Myoviridae | <1-80% |
| LL12-Myoviridae | <1-80% |

The components and/or weight percentages used in the compositions disclosed herein, such those shown above, can vary based on supplier source, fermentation, seasonal availability, harvest timing, and supply of particular pre, probiotic, postbiotic and/or bacteriophage based sources. For example, if a particular component is unavailable due source of supply, another component from the same or another genus, species or bioidentical strain or species from a different supplier may be used as a replacement at the same or different weight percentage.

Additional, nonlimiting examples within the scope of this disclosure include:

Example 1: A composition comprising: at least one prebiotic component and/or at least one probiotic component and/or at least one postbiotic constituent component and/or at least one bacteriophage component.

Example 2: The composition of Example 1, wherein the composition comprises both the at least one prebiotic component and the at least one probiotic component.

Example 3: The composition of Example 1 or Example 2, wherein the at least one prebiotic component, the at least one probiotic component, and/or the at least one postbiotic constituent component are delivered in freeze dried, spray dried, spray, capsule, emulsion, dried powder, fast melt, effervescent tablet, capsule, dual chamber capsule, liquid capsule, liquid beadlet, caplet, and or solid beadlet.

Example 4: The composition of Example 3, wherein the at least one prebiotic component, the at least one probiotic component, the at least one postbiotic constituent component, and the at least one bacteriophage component are dehydrated by a low temperature drying method, sublimation or other high pressure method.

Example 5: The composition of Example 4, wherein one or more strains of the at least one probiotic component are sourced from human, animal or plant natural fermentation synthesis using a low temperature drying method selected from the group consisting of rapid zone drying, and/or window refractance, sublimation, freeze drying, and/or vacuum belt drying and/or other low temperature drying methods.

Example 6: The composition of any of Examples 1 through 5, wherein the composition comprises at least one separate prebiotic or prebiotic fibrous constituent component plus 24 probiotic strains.

Example 7: The composition of any of Examples 1 through 5, wherein the composition comprises at least one prebiotic component, at least 24 strains of probiotic components, at least one postbiotic constituent component, and at least 4 bacteriophage components.

Example 8: The composition of any of Examples 1 through 7, wherein the at least one prebiotic component comprises a sourced inulin fructooligosaccharide (FOS).

Example 9: The composition of any of Examples 1 through 8, wherein the at least one probiotic component comprises at least one strain listed in Table 1.

Example 10: The composition of any of Examples 1 through 9, wherein the composition is packaged in a sterilized container or package.

Example 11: The composition of any of Examples 1 through 10, wherein the composition comprises a liquid, spray dried material, tablet, caplet, softgel, beadlet, gum, mixed drink, food additive, smoothie, fruit drink, shake, flavoring, baby food, sports supplemental product, baked good, pet product, or other food product.

Example 12: The composition of any of Examples 1 through 10, wherein the composition a cosmetic or topical product.

Example 13: The composition of Example 12, wherein the composition comprises a lotion, shampoo, conditioner, makeup, cream, soap, gel, foam, ear drops, eye drops, inhaler, mist, or ointment.

Example 14: The composition of any of Examples 1 through 13, further comprising one or more additional ingredients selected from the group consisting of essential oils, spices, herbs, natural sweeteners, phytonutrients, vitamins, minerals, and food additives for preservation of taste, freshness, or mouthfeel.

Example 15: The composition of any of Examples 1 through 14, wherein a weight percent of each of the at least one prebiotic component, the at least one probiotic component, the at least one postbiotic constituent component, and the at least one bacteriophage in the composition is between 1 and 99.

Example 16: The composition of any of Examples 1 through 15, wherein the composition comprises an emulsion, food form, liquid, gel, beadlet, softgel, powder, gum, flakes, tablet, or capsule.

Example 17: The composition of any of Examples 1 through 16, wherein the composition is free of artificial flavors, preservatives, colors, binders, and fillers.

Example 18: A method of using a composition, comprising: administering to a human or an animal a composition comprising at least one prebiotic component and/or at least one probiotic component and/or at least one postbiotic constituent component and/or at least one bacteriophage component in an amount sufficient to act as a nutritional source or supplement.

Example 19: The method of Example 18, wherein administering the composition comprises administering the at least one prebiotic component as a sourced inulin fructooligosaccharide (FOS) in an amount of from 0.1 mcg per day to 20,000 mg per day.

Example 20: The method of Example 18 or Example 19, wherein administering the composition comprises administering strains of the at least one probiotic component from the sources listed in Table 1, each in an amount from 0.1 mcg per day to 20,000 mg per day.

Example 21: The method of any of Examples 18 through 20, wherein administering the composition comprises administering each of the at least one postbiotic constituent component and the at least one bacteriophage component in an amount from 0.1 mcg per day to 20,000 mg per day.

Example 22: A method of making a composition, comprising: mixing at least one prebiotic component and/or at least one probiotic component and/or at least one postbiotic constituent component and/or at least one bacteriophage component with one another until at least substantially homogenous.

The foregoing description of illustrative examples has been presented for purposes of illustration and of description. It is not intended to be exhaustive or limiting with respect to the precise form disclosed, and modifications and variations are possible in light of the above teachings or may be acquired from practice of the disclosed aspects of the present invention. It is intended that the scope of the present invention be defined by the claims appended hereto and their equivalents.

What is claimed is:

1. A composition comprising:
at least one prebiotic component and/or at least one probiotic component and/or at least one postbiotic constituent component and/or at least one bacteriophage component.

2. The composition of claim 1, wherein the composition comprises both the at least one prebiotic component and the at least one probiotic component.

3. The composition of claim 1, wherein the at least one prebiotic component, the at least one probiotic component, and/or the at least one postbiotic constituent component are delivered in freeze dried, spray dried, spray, capsule, emulsion, dried powder, fast melt, effervescent tablet, capsule, dual chamber capsule, liquid capsule, liquid beadlet, caplet, and or solid beadlet.

4. The composition of claim 3, wherein the at least one prebiotic component, the at least one probiotic component, the at least one postbiotic constituent component, and the at least one bacteriophage component are dehydrated by a low temperature drying method, sublimation or other high pressure method.

5. The composition of claim 4, wherein one or more strains of the at least one probiotic component are sourced from human, animal or plant natural fermentation synthesis using a low temperature drying method selected from the group consisting of rapid zone drying, and/or window refractance, sublimation, freeze drying, and/or vacuum belt drying and/or other low temperature drying methods.

6. The composition of claim 1, wherein the composition comprises at least one separate prebiotic or prebiotic fibrous constituent component plus 24 probiotic strains.

7. The composition of claim 1, wherein the composition comprises at least one prebiotic component, at least 24 strains of probiotic components, at least one postbiotic constituent component, and at least 4 bacteriophage components.

8. The composition of claim 1, wherein the at least one prebiotic component comprises a sourced inulin fructooligosaccharide (FOS).

9. The composition of claim 1, wherein the at least one probiotic component comprises at least one strain listed in Table 1.

10. The composition of claim 1, wherein the composition is packaged in a sterilized container or package.

11. The composition of claim 1, wherein the composition comprises a liquid, spray dried material, tablet, caplet, softgel, beadlet, gum, mixed drink, food additive, smoothie, fruit drink, shake, flavoring, baby food, sports supplemental product, baked good, pet product, or other food product.

12. The composition of claim 1, wherein the composition a cosmetic or topical product.

13. The composition of claim 12, wherein the composition comprises a lotion, shampoo, conditioner, makeup, cream, soap, gel, foam, ear drops, eye drops, inhaler, mist, or ointment.

14. The composition of claim 1, further comprising one or more additional ingredients selected from the group consisting of essential oils, spices, herbs, natural sweeteners, phytonutrients, vitamins, minerals, and food additives for preservation of taste, freshness, or mouthfeel.

15. The composition of claim 1, wherein a weight percent of each of the at least one prebiotic component, the at least one probiotic component, the at least one postbiotic constituent component, and the at least one bacteriophage in the composition is between 1 and 99.

16. The composition of claim 1, wherein the composition comprises an emulsion, food form, liquid, gel, beadlet, softgel, powder, gum, flakes, tablet, or capsule.

17. The composition of claim 1, wherein the composition is free of artificial flavors, preservatives, colors, binders, and fillers.

18. A method of using a composition, comprising:
administering to a human or an animal a composition comprising at least one prebiotic component and/or at least one probiotic component and/or at least one postbiotic constituent component and/or at least one bacteriophage component in an amount sufficient to act as a nutritional source or supplement.

19. The method of claim 18, wherein administering the composition comprises administering the at least one prebiotic component as a sourced inulin fructooligosaccharide (FOS) in an amount of from 0.1 mcg per day to 20,000 mg per day.

20. The method of claim 18, wherein administering the composition comprises administering strains of the at least one probiotic component from the sources listed in Table 1, each in an amount from 0.1 mcg per day to 20,000 mg per day.

21. The method of claim 18, wherein administering the composition comprises administering each of the at least one postbiotic constituent component and the at least one bacteriophage component in an amount from 0.1 mcg per day to 20,000 mg per day. 22 A method of making a composition, comprising:
mixing at least one prebiotic component and/or at least one probiotic component and/or at least one postbiotic constituent component and/or at least one bacteriophage component with one another until at least substantially homogenous.
